(19) United States
(12) Patent Application Publication
(10) Pub. No.: US 2004/0204036 A1
(43) Pub. Date: Oct. 14, 2004

(54) Configurable multi-band RF transceiver with a cascaded frequency conversion scheme

(75) Inventor: Steve S. Yang, Newark, CA (US)

Correspondence Address: C.P. Chang, c/o Pacific Law Group LLP, Suite 290, 2 North Second Street, San Jose, CA, 95113, US

(73) Assignee: Fodus Communications, Inc., Sunnyvale, CA (US)

(21) Appl. No.: 10/289,267

(22) Filed: Nov. 5, 2002

(51) Int. Cl. H04B 1/26; H04B 15/00; H04M 1/00; H04B 1/38

(52) U.S. Cl. 455/553.1; 455/313; 455/323; 455/552.1

(57) ABSTRACT

A configurable dual-band RF transceiver with a cascaded frequency conversion scheme (DBXVR) is disclosed for the processing of any selected RF channel signal specified by the open standard IEEE 802.11 a/b/g for Wireless LAN. The DBXVR comprises two switchably connected antennae for receiving and transmitting any selected RF channel signal and two subsets of signal processing hardware. The first signal processing subset is designed to perform all related frequency conversion, signal filtering and amplification between the b/g-band and its corresponding Baseband Inphase (I) and Quadrature (Q) signals. The second signal processing subset is designed to perform all related frequency conversion, signal filtering and amplification between the a-band, located at a disjointed and much higher frequency range than the b/g-band, and its corresponding b/g-band frequency for an ultimate, cascaded second signal processing into the Baseband I and Q signals using essentially the same hardware from the first signal processing subset.

### FIELD OF THE INVENTION

The present invention relates generally to the field of wireless communication. More particularity, the present invention concerns the design architecture of a wireless LAN transceiver meeting a worldwide open standard of IEEE802.11 a/b/g comprising three RF (Radio Frequency) bands a, b and g.

### BACKGROUND OF THE INVENTION

The present invention concerns the design architecture of a wireless LAN transceiver meeting a worldwide open standard of IEEE802.11 a/b/g comprising three RF (Radio Frequency) bands a, b and g. Traditionally, the approach to converting all RF channels of these RF bands into a common IF (Intermediate Frequency) signal employs a unique conversion hardware for each of the three bands a, b and g. This implies the design and deployment of three hardware systems with accompanying disadvantages of complexity as to final product integration and associated inventory control. Thus, the present invention aims at a simplified approach wherein a single hardware system is designed and deployed for the transceiving of an RF signal within any of the aforementioned RF bands a, b and g to eliminate these disadvantages.

### SUMMARY OF THE INVENTION

The present invention is directed to a new approach to converting all RF channels of the three IEEE802.11 a, b and g bands to a common IF signal band with one or more cascaded conversions. The first objective of this invention is to achieve the just-stated frequency conversions with a single conversion hardware.

The second objective of this invention is to achieve a single hardware architecture that is extendable to the frequency conversions of more than just three RF bands, as listed under the standard of IEEE802.11 a/b/g, to a common IF signal.

Other objectives, together with the foregoing are attained in the exercise of the invention in the following description and resulting in the embodiment illustrated in the accompanying drawings.

### BRIEF DESCRIPTION OF DRAWINGS

The current invention will be better understood and the nature of the objectives set forth above will become apparent when consideration is given to the following detailed description of the preferred embodiments. For clarity of explanation, the detailed description further makes reference to the attached drawings herein:

FIG. 1 shows a conventional transceiver architecture for processing the IEEE802.11 b/g channel signals;

FIG. 2 shows the present invention transceiver architecture for processing the IEEE802.11 a/b/g channel signals; and

FIG. 3 is a qualitative overview of the cascaded frequency conversion scheme of the present invention as applied to the IEEE802.11 a/b/g channel signals.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessary obscuring aspects of the present invention. The detailed description is presented largely in terms of logic blocks and other symbolic representations that directly or indirectly resemble the operations of signal processing devices coupled to networks. These descriptions and representations are the means used by those experienced or skilled in the art to most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations of the invention.

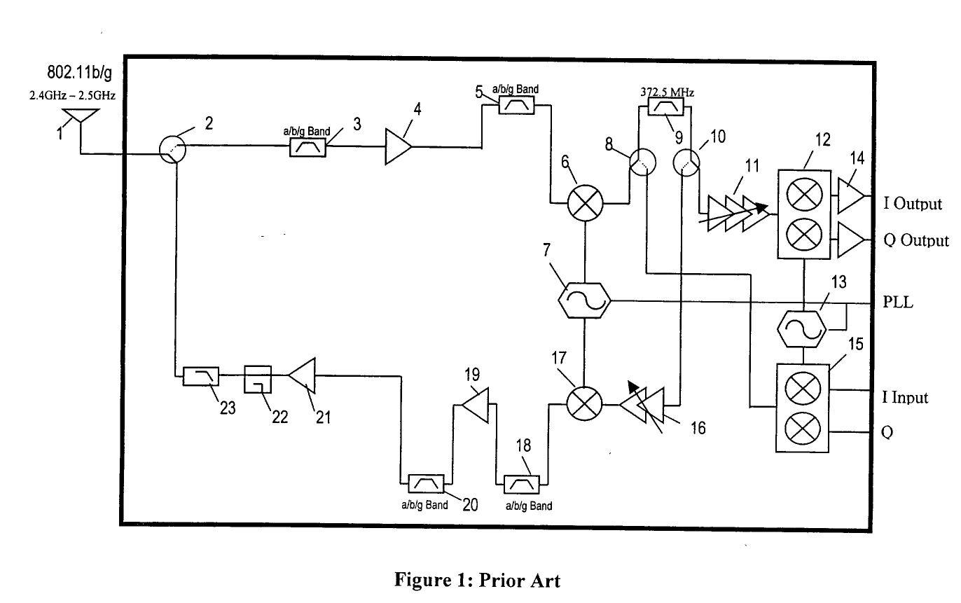

FIG. 1 shows an example of a conventional transceiver architecture for processing the IEEE802.11 b/g channel signals. For clarity, the corresponding channel numbers and center frequencies are listed under columns one and two in Table 1, As an example, channel 5 has a Center Frequency of 2432 MHz (Megahertz, 10⁶ cycles/sec), etc. Also for future clarity, the corresponding channel numbers and center frequencies for a-band low frequencies and a-band high frequencies are listed under columns one and two in Table 2 wherein channels 36 through 64 represent a-band low frequencies while channels 149 through 161 represent a-band high frequencies. Channel 157 of a-band high frequencies has a Center Frequency of 5785 MHz, etc. Thus, the a-band low frequency channels generally cluster around 5.2 GHz (Gigahertz, 10⁹ cycles/sec) while the a-band high frequency channels generally cluster around 5.7 GHz.

Referring still to FIG. 1, starting with the receiver side of the conventional transceiver as illustrated is in the upper side of FIG. 1, an antenna 1 for receiving and transmitting any RF channel signal within the IEEE802.11 b- and g-band is switchably connected to the rest of the receiver. That is, an incoming RF signal from the antenna 1 goes through a transceiver switch 2 and passes through a b/g-Band filter 3 to an LNA 4 thereby amplified to a higher signal level above the sum total of all noises generated by all the subsequent processing stages. Emerging from the LNA 4, the signal goes through another bandpass filter 5 to suppress any image noise generated by the LNA 4 plus any unwanted out band signals. The channel signal is then converted to an IF (Intermediate Frequency) by a mixer 6 using a Local Oscillator Frequency (LOF) generated by a coupled combination of a VCO (Voltage Control Oscillator) 7 and a Phase Locked Loop (PLL). For this example, the IF center frequency is selected to be 372 MHz for the conversion of all the b/g-band channels into this IF frequency. The b/g-band channel frequencies, the corresponding LOF and the resulting IF center frequencies are listed in Table 1:

TABLE 1
IEEE 802.11 b/g Frequency Conversion Parameters under
Conventional Approach

| | Center | Local Oscillator | | I/Q LOF and IF Center |
|---|---|---|---|---|
| Channel | Frequency | Frequency (LOF) | Divider | Frequencies |
| Number | (MHz) | (MHz) | N | (MHz) |
| 1 | 2412 | 2040 | 408 | 372 |
| 2 | 2417 | 2045 | 409 | 372 |
| 3 | 2422 | 2050 | 410 | 372 |
| 4 | 2427 | 2055 | 411 | 372 |
| 5 | 2432 | 2060 | 412 | 372 |
| 6 | 2437 | 2065 | 413 | 372 |
| 7 | 2442 | 2070 | 414 | 372 |
| 8 | 2447 | 2075 | 415 | 372 |
| 9 | 2452 | 2080 | 416 | 372 |
| 10 | 2457 | 2085 | 417 | 372 |
| 11 | 2462 | 2090 | 418 | 372 |
| 12 | 2467 | 2095 | 419 | 372 |
| 13 | 2472 | 2100 | 420 | 372 |
| 14 | 2484 | 2112 | 264 | 372 |

| | | |
|---|---|---|
| Reference Frequency | 5/8 | 1 MHz |
| | MHz | |

In Table 1, column 1 is an assigned RF channel number as defined in IEEE802.11 b/g. Column 2is the center frequency of the RF channel. Column 3 is an LOF, when applied to the mixer 6, that will convert an RF channel frequency into the IF center frequency of 372 MHz. For example:

an LOF of 2065 MHz will convert a channel 6 RF signal, at a center frequency of 2437 MHz, into 2437 MHz−2065 MHz=372 MHz, the desired IF center frequency, etc.

To generate the complete set of LOF of column 3, one or more reference frequencies, each of them being a common integral divisional factor of a subset of the set of LOF, are required by the coupled combination of the VCO 7 and the PLL and can be calculated accordingly. The calculated reference frequencies are listed at the bottom of column 4. In this example, the reference frequencies are 5 MHz and 8 MHz with:

2040 MHz/408=5 MHz;

2045 MHz/409=5 MHz;

2050 MHz/410=5 MHz;

2055 MHz/411=5 MHz;

2060 MHz/412=5 MHz;

2065 MHz/413=5 MHz;

2070 MHz/414=5 MHz;

2075 MHz/415=5 MHz;

2080 MHz/416=5 MHz;

2085 MHz/417=5 MHz;

2090 MHz/418=5 MHz;

2095 MHz/419=5 MHz;

2100 MHz/420=5 MHz; and

2112 MHz/264=8 MHz.

The last column, column 5, is the desired IF center frequency after conversion that is also an I/Q (In-phase/Quadrature phase) LOF. Back to FIG. 1 again, after the channel signal gets converted to the IF, it passes through an analog switch 8 then through a 372.5 MHz IF bandpass filter 9 to remove all other unwanted channel signals and out band noises. Notice that the transmitter side is the lower side of FIG. 1. Therefore, in this architecture, the IF bandpass filter 9 is time shared, through the operation of analog switch 8 and analog switch 10, between the receiver and the transmitter. After passing through the analog switch 10, the channel signal, at the IF frequency, goes into an Automatic Gain Control (AGC) amplifier 11 to adjust the signal amplitude to a required level for I/Q conversion by I/Q conversion 12. The I/Q conversion 12 requires two mixers using two LOFs, called I/Q LOFs, with a phase difference of 90 degrees between them. The I/Q LOFs are generated, at the IF Center Frequency of 372 MHz, by a coupled combination of a VCO 13 and the PLL. Hence, the IF channel signal mixed with an in-phase component of the I/Q LOFs creates an I video output, labeled as I output. The IF channel signal mixed with a quadrature component of the I/Q LOFs creates a Q video output, labeled as Q output. The two signals I output and Q output are called baseband signals. Finally, the baseband signals are amplified by a video amplifier 14 to a pre-determined level for analog-to-digital conversion and subsequent digital signal processing.

At the transmitter side that is the lower side of FIG. 1, the direction of signal processing is generally reversed from that of the receiver. First the I Input and Q Input signals, coming from a digital signal processor, are fed into an V/Q mixer 15 thus converted into IF signals. These IF signals are then summed together to form a transmitter IF signal. Next, the transmitter IF signal, through properly set analog switches 8 and 10, is passed through the IF bandpass filter 9 to clean up out band noises and to avoid interference from any adjacent channels after transmission. Next, the cleaned up signal goes to an Automatic Level Control (ALC) amplifier 16 for a desired level of radiated output RF power. Then the amplified IF signal frequency gets converted upwards, via mixer 17, to the required b/g-band RF frequency. However, during this upward frequency conversion, not only a desired b/g-band signal is generated at a frequency of LOF frequency plus IF, but also an unwanted side band signal is generated at a frequency of LOF frequency minus IF, now between 1.65 GHz and 1.75 GHz. As this unwanted side band signal is prohibited from transmission by the FCC regulatory agency, an RF filter 18 is inserted to remove it. Next, a driving amplifier 19 amplifies the desired RF channel signal to a sufficient level, followed by yet another stage of RF filter 20 to further reduce the unwanted LOF frequency minus IF side band signal to a level acceptable to the FCC regulatory agency, to drive a power amplifier 21 for final power amplification. After final power amplification, the powered RF channel signal goes through a power detector 22 to monitor the output power level for ALC control. Before the powered RF channel signal gets sent out through the transceiver switch 2, it passes through a final low pass filter 23 to suppress any residual harmonics to avoid an associated interference with other communicating channel signals. Finally, the powered RF channel signal goes through the transceiver switch 2 to the antenna 1 for final radiation.

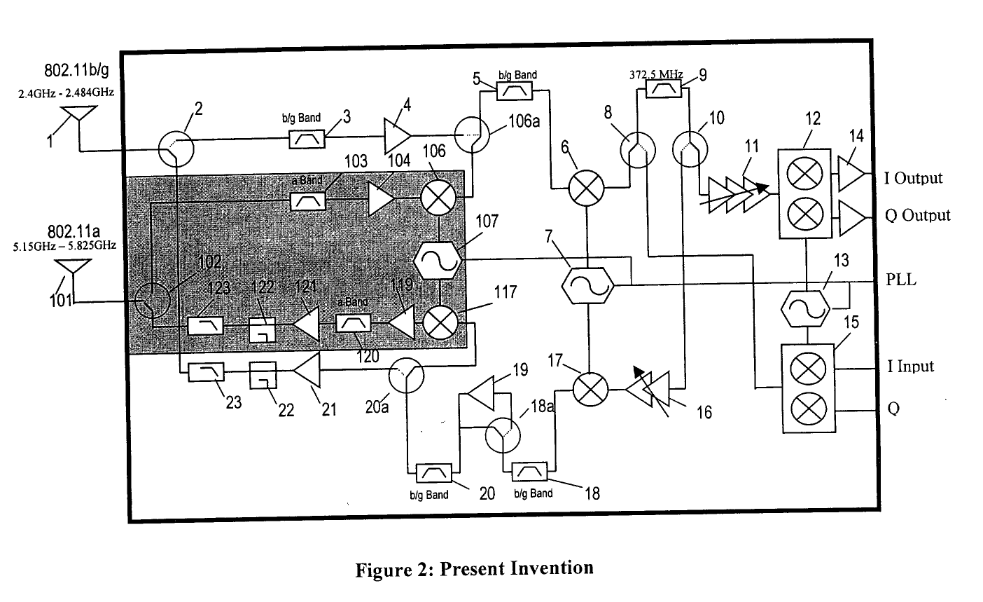

FIG. 2 shows an example of the present invention transceiver architecture for processing the IEEE802.11 a/b/g channel signals. Notice that the present invention architecture is evolved from the conventional architecture. Thus, the portion of the present invention architecture characterized by the antenna 1, the transceiver switch 2, the b/g-Band filter 3, . . . , the power detector 22 and the low pass filter 23 are essentially the same as described before and are for the processing of IEEE 802.11 b/g-band channel signals. However, for the processing of the additional IEEE 802.11 a-band channel signals located within a substantially higher and disjointed RF-band, instead of just replicating the conventional architecture hardware with an accompanying quantitative design adjustment to suit the parameters for the IEEE 802.11 a-band, the present invention proposes to simply add a small amount of incremental hardware, on top of the conventional architecture for IEEE 802.11 b/g-band processing, for first converting the IEEE 802.11 a-band channel signals into the b/g-band followed by a cascaded second conversion, using the existing conventional architecture hardware, into the final base band signals.

As already mentioned before and with reference made to Table 2, IEEE 802.11 a-band comprises two sub-bands with a lower sub-band frequency from 5.18 GHz to 5.32 GHz and an upper sub-band frequency from 5.745 GHz to 5.805 GHz. Thus, for the conversion of signal frequency under the present invention, the channel signals are not directly converted to the IF signal, instead they are converted into a down-conversion transitional frequency f_{dtr} within the b/g-band first thus allowing the usage of an accompanying LOF that is much lower in magnitude, hence correspondingly easier to generate, than otherwise possible in a case where the channel signals are directly converted to the IF signal. Additionally, still under the present invention, the down-conversion transitional frequency f_{dtr} does not have to correspond to any particular channel within the b/g-band (channels 1-14 of Table 1) and this offers the additional advantage of increased design freedom. Furthermore, as just explained above, this approach takes advantage of the already well designed and available RF circuitry for b/g-band processing. An additional advantage is that, during the conversion of an a-band signal into b/g-band with a mixer, a correspondingly generated unwanted sideband signal frequency of LOF minus IF is below 1 GHz and this can be easily rolled off by an LNA followed with a power amplifier.

Focusing now on the newly added and shaded area of FIG. 2 dealing with the signal conversion of a-band, with an a-band low around 5.2 GHz and an a-band high around 5.7 GHz, into b/g-band. Starting with the receiver that is the upper portion of the shaded area, an a-band RF signal comes in from antenna 101. The received RF signal from the antenna 101, through a properly set transceiver switch 102, passes through an a-Band filter 103 to an LNA 104. Emerging from the LNA 104, the filtered and amplified a-band RF channel signal gets converted into the b/g-band by a mixer 106 using an LOF generated by a coupled combination of a VCO 107 and the PLL. Referring to column 2 of Table 1 and Table 2, as the b/g-band covers a total of more than 90 MHz in bandwidth and the bandwidth of each a-band channel is only about 20 MHz, any a-band channel signal can be easily converted into the down-conversion transitional frequency f_{dtr} within the b/g-band for further filtering and conversion into a desired IF at either 372 MHz or 373 MHz. Furthermore, in general, numerically there are more than one way to convert the complete set of a-band signals into the b/g-band. Thus, Table 2 lists one possibility of frequency conversion parameters from a-band to b/g-band under the present invention.

TABLE 2
IEEE 802.11 One Possibility of Frequency Conversion Parameters from a-band
to b/g-band under the Present Invention

| | | | | Down- | | | |
|---|---|---|---|---|---|---|---|
| | | | | conversion | | | |
| | | | | transitional | | | |
| | | | | frequency | | | I/Q LOF |
| | | | | (f_{dtr}) within | | | and IF |
| | Center | | | the range of | | | Center |
| Channel | Frequency | 1st LOF | | b/g Band | 2nd LOF | | Frequencies |
| Number | (MHz) | (MHz) | Divider N | (MHz) | (MHZ) | Divided n | (MHz) |
| 36 | 5180 | 2760 | 138 | 2420 | 2048 | 256 | 372 |
| 40 | 5200 | 2780 | 139 | 2420 | 2048 | 256 | 372 |
| 44 | 5220 | 2800 | 140 | 2420 | 2048 | 256 | 372 |
| 48 | 5240 | 2820 | 141 | 2420 | 2048 | 256 | 372 |
| 52 | 5260 | 2800 | 140 | 2460 | 2088 | 261 | 372 |
| 56 | 5280 | 2820 | 141 | 2460 | 2088 | 261 | 372 |
| 60 | 5300 | 2840 | 142 | 2460 | 2088 | 261 | 372 |
| 64 | 5320 | 2860 | 143 | 2460 | 2088 | 261 | 372 |
| 149 | 5745 | 3300 | 165 | 2445 | 2072 | 259 | 373 |
| 153 | 5765 | 3320 | 166 | 2445 | 2072 | 259 | 373 |
| 157 | 5785 | 3340 | 167 | 2445 | 2072 | 259 | 373 |
| 161 | 5805 | 3360 | 168 | 2445 | 2072 | 259 | 373 |

| | | | |
|---|---|---|---|
| Reference Frequency | 20 MHz | 8 MHz | 1 MHz |

As shown in Table 2, column 1 lists a series of assigned RF channel numbers as defined in IEEE802.11 a. Column 2 lists the corresponding center frequencies of the RF channels. Column 3 lists a first series of corresponding LOFs, when applied to the mixer 106, that will convert an a-band channel frequency into the f_{dtr} within the b/g-band. For example:

A first LOF of 2820 MHz will convert an a-band channel signal, at a center frequency of 5280 MHz, into an f_{dtr}=5280 MHz−2820 MHz=2460 MHz, that is within the b/g-band,

To generate the complete set of first LOFs of column 3, one or more reference frequencies, each of them being a common integral divisional factor of a subset of the set of first LOFs, are required by the coupled combination of the VCO 107 and the PLL and can be calculated accordingly. In this case, a single calculated reference frequency of 20 MHz is found and listed at the bottom of column 4. That is:

2760 MHz/138=20 MHz;

2780 MHz/139=20 MHz;

2800 MHz/140=20 MHz; and so on; and

3360 MHz/168=20 MHz.

Column 5 lists the correspondingly converted, from an a-band channel frequency, down-conversion transitional frequency f_{dtr} within the b/g-band. Similar to the parameter structure as listed and already explained in columns 3 through 5 of Table 1, columns 6 through 8 of Table 2 list parameters relevant to a second frequency conversion from the just-obtained down-conversion transitional frequency f_{dtr} to an IF signal at either 372 MHz of 373 MHz to be further converted again into I and Q video outputs.

Continuing with FIG. 2, after the received a-band channel signal gets converted into the down-conversion transitional frequency f_{dtr} within the b/g Band by the mixer 106, the converted signal f_{dtr} goes through an analog switch 106a and the bandpass filter 5 to the second conversion mixer 6 with the corresponding second LOF generated by the coupled combination of the VCO 7 and the PLL, for conversion into an IF frequency, listed under column 6 of Table 2. After conversion into the IF frequency and in the same manner as discussed above for b/g-band IF processing, the converted IF signal goes through the analog switch 8, the IF bandpass filter 9, the analog switch 10 and the AGC amplifier 11 followed by further conversion into two baseband signals I output and Q output for analog-to-digital conversion and subsequent digital signal processing.

For the transmitter function that is the lower portion of the shaded area of FIG. 2, the signal processing starts in exactly the same way as discussed above for b/g-band transmission of FIG. 1. Signals I Input and Q Input from a Digital-to-Analog converter (DAC, not shown) goes to the I/Q mixer 15 and get up converted into the IF frequency band including a 372 MHz, same as that for the b/g-band, for the lower a-band and a 373 MHz, only 1 MHz higher than that for the b/g-band, for the upper a-band. As these two IF center frequencies are so closely spaced, they can use the same IF bandpass filter 9, after going through the analog switch 8, to suppress any out of band signals and noises. The filtered signal then goes through the analog switch 10 to the ALC amplifier 16 for an adjustment of the transmitter output power level. The power level adjusted IF signal then gets converted into an up-conversion transitional frequency fᵤₜᵣ within the b/g-band by the mixer 17. It is remarked that, while both the f_{dtr} and the fᵤₜᵣ are located within the b/g-band and they can be set to equal to each other, numerically they do not have to have any particular functional relationship between them. Furthermore, for those skilled in the art, except for the difference in the direction of frequency conversion, the general operating principle upon which the fᵤₜᵣ is arrived is quite similar to that for the f_{dtr} and is therefore not further illustrated with another table. Next, the converted signal fᵤₜᵣ within the b/g-band goes through the RF filter 18, bypassing the b/g-band driving amplifier 19 via the action of an analog switch 18a, for further filtration by the second RF filter 20. Next, the further filtered signal goes through an analog switch 20a for another frequency up conversion with a mixer 117 into the finally desired a-band. It is remarked that, another reason to convert the a-band signal into the b/g-band is to leverage the RF filters 18 and 20, already employed for b/g-band processing, to clean up any unwanted sideband signals. However, as the a-band channel signal still needs to go through another frequency up conversion, it does not require an amplifier gain from the driving amplifier 19 hence it is bypassed with an action of the analog switch 18a. The converted a-band channel signal is then amplified by an a-band driving amplifier 119. In this case, as the unwanted sideband signal is below 1 GHz, the driving amplifier 119 only needs to amplify a-band signals between 5 GHz and 6 GHz while cutting off any input signal below 1 GHz. After amplification by the driving amplifier 119, the channel signal goes through an a-band bandpass filter 120 to suppress any mixer 117 leakage between 2.76 GHz and 3.36 GHz and to further reduce any residual sideband signal below 1 GHz. The channel signal is then finally amplified by a power amplifier 121 and goes through a power detector 122, a low pass filter 123 and a transceiver switch 102 to the antenna 101 in the same manner as the case for b/g-band transmission.

As a general remark for further clarification of the present invention for those skilled in the art, the major elements of an RF wireless transceiver are amplifiers, filters, and mixers. The amplifier is used for signal amplification. The filter is used to remove unwanted signals. The mixer is used for converting a signal from one frequency to another for further signal filtering and amplification. The mixer is a nonlinear device. That is, during the frequency conversion process, the mixer not only generates a desired frequency but also simultaneously generates another unwanted frequency. For example, given an LOF of fa being mixed with a signal frequency of fb for an up conversion, the mixer generates a desired output frequency at (fa+fb) and another unwanted output frequency at (fa−fb). The output component at frequency (fa+fb), being higher than the LOF fa, is called the upper sideband, and the output component at frequency (fa−fb), being lower than the LOF fa, is called the lower sideband. A filter is thus required to remove the unwanted lower sideband. For another example, when one converts a signal at frequency fb to frequency (fa+fb), a signal at frequency (2fa+fb) also gets converted to (fa+fb) as (2fa+fb)−fb=(fa+fb). For those skilled in the art, the signal (2fa+fb) is called an image of the signal fb. Generally, a frequency plan for an RF wireless transceiver involves the selection of a set of proper LOFs to make the whole transceiver more efficient in the handling of frequency conversion, unwanted signal filtering and amplification of desire signals. Therefore, the unique frequency plan of the present invention with a cascaded conversion of multiple frequency bands affords an overall simplified system design for product integration.

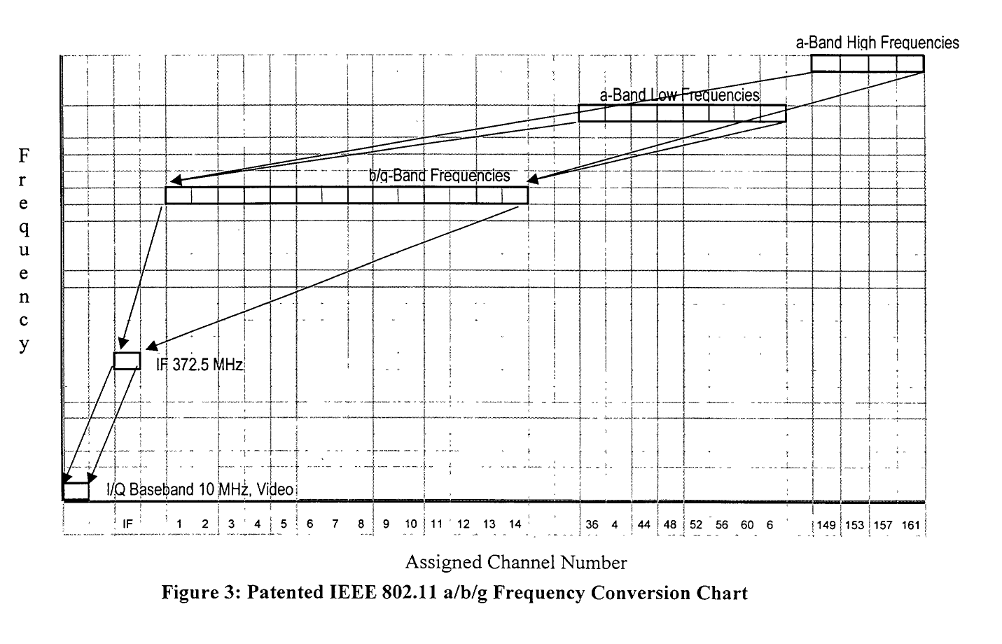

Additional accompanied design advantages provided by the present invention are a simple set of LOFs to generate, relatively relaxed filtering requirements and only a few places of required signal amplification. FIG. 3 is a qualitative overview of the just presented cascaded frequency downward-conversion scheme of the present invention as applied to the IEEE802.11 a/b/g channel signals. As shown, the b/g-band frequencies get converted into the IF frequency centering at 372.5 MHz followed by a further conversion into the I/Q base band video at 10 MHz. Under the cascaded frequency downward-conversion scheme of the present invention, both the a-band low frequency and the a-band high frequency signals are downward-converted into a down-conversion transitional frequency f_{dtr} within the b/g-band first. The f_{dtr} is then further downward-converted into IF and base band using the same hardware for the previous b/g-band processing. Consistently, although not graphically illustrated here, the cascaded frequency upward-conversion scheme of the present invention is characterized by first sequentially upward-converting the base band signal into IF followed by an up-conversion transitional frequency fᵤₜᵣ within the b/g-band using the same hardware for the previous b/g-band processing. The fᵤₜᵣ is then further upward-converted into a desired channel signal within the a-band.

As described with an exemplary case of RF wireless transceiver implementing the world wide open standard IEEE802.11 a/b/g for Wireless LAN, a configurable multi-band RF transceiver (MBXVR) with a cascaded frequency conversion scheme is disclosed for the processing of any selected single operating frequency RF channel signal from two disjointed RF-bands consisting of the b/g-band located at a lower frequency and the a-band located at a substantially higher frequency. However, for those skilled in this field, the preferred embodiments can be easily adapted and modified to suit additional applications without departing from the spirit and scope of this invention. For example, the cascaded frequency conversion scheme of the present invention can clearly be extended to a generalized case, without departing from the fundamental spirit of the invention, wherein the MBXVR is capable of processing any selectable single operating frequency RF channel signal from a number N, with N>1, of disjointed RF-bands of increasing frequency RFB-1, RFB-2, . . . , RFB-N. Additionally, in terms of application the present invention can be applied to a more generalized Optical communication at 2.5 Gbit/sec (OC48), 10 Gbit/sec (OC192) and 40 Gbit/sec (OC768) data rate, Gigabit Ethernet, 10 Gigabit Ethernet and Blue Tooth technology (2.4 GHz).

Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

1. A dual-band RF transceiver (DBXVR) for processing an RF channel signal of selected operating frequency from two disjointed RF-bands of increasing frequency, RFB-1 and RFB-2, the DBXVR comprising:
a first antenna, for receiving and transmitting an RF channel signal within said RFB-1 wherein said RFB-1 having a number B1 of selectable channels of discrete increasing operating frequencies f₁₁, f₁₂, . . . f_{1B1};
means to receive said RFB-1 RF signal, being switchably coupled to said first antenna, said RFB-1 RF signal receiving means further comprises a first frequency downward conversion means for downward-conversion of any of said operating frequencies f₁₁, f₁₂, . . . f_{1B1} into an Intermediate Frequency (IF) signal of essentially a common frequency f_{IF} and a second frequency downward conversion means for further downward-conversion of said IF signal into a first set of Baseband Inphase (I) and Quadrature (Q) signals;
means to transmit said RFB-1 RF signal, being switchably coupled to said first antenna, said RFB-1 RF signal transmitting means further comprises a first frequency upward conversion means for upward-conversion of a second set of Baseband I and Q signals into essentially said common frequency f_{IF} and a second frequency upward conversion means for upward-conversion of said common frequency f_{IF} into one of said operating frequencies f₁₁, f₁₂, . . . f_{1B1} to be transmitted through a corresponding channel of said RFB-1;
a second antenna, for receiving and transmitting an RF channel signal within said RFB-2 wherein said RFB-2 having a number B2 of selectable channels of discrete increasing operating frequencies f₂₁, f₂₂, . . . , f_{2B2};
means to receive said RFB-2 RF signal, being switchably coupled to said second antenna and said first and second frequency downward conversion means, said RFB-2 RF signal receiving means further comprises a third frequency downward conversion means for downward-conversion of any of said operating frequencies f₂₁, f₂₂, . . . , f_{2B2} into a down-conversion transitional frequency f_{dtr} essentially within the frequency range of (f₁₁, f_{1B1}) wherein said f_{dtr} is further converted by said first frequency downward conversion means into essentially said common frequency f_{IF} that is further converted by said second frequency downward conversion means into a third set of Baseband I and Q signals; and
means to transmit said RFB-2 RF signal, being switchably coupled to said second antenna and said first and second frequency upward conversion means, said RFB-2 RF signal transmitting means further comprises a third frequency upward conversion means for upward-conversion of a fourth set of Baseband I and Q signals into one of said operating frequencies f₂₁, f₂₂, . . . , f_{2B2} to be transmitted through a corresponding channel of said RFB-2 after said fourth set of Baseband I and Q signals being first converted into essentially said common frequency f_{IF} by said first frequency upward conversion means following by further conversion of said common frequency f_{IF} into an up-conversion transitional frequency fᵤₜᵣ essentially within the frequency range of (f₁₁, f_{1B1}) by said second frequency upward conversion means wherein said fᵤₜᵣ is further converted by said third frequency upward conversion means into said one of said operating frequencies f₂₁, f₂₂, . . . , f_{2B2}.

2. The DBXVR of claim 1 further comprises an analog system switching means for selectively connecting said first and second antennae, said RFB-1 RF signal receiving means, said RFB-1 RF signal transmitting means, said RFB-2 RF signal receiving means and said RFB-2 RF signal transmitting means to effectuate the receiving and transmission of any RF channel signal from said RFB-1 and RFB-2.

3. The DBXVR of claim 1 wherein said first frequency downward conversion means comprises a first coupled combination of a VCO (Voltage Control Oscillator) and a Phase Locked Loop (PLL) to generate a first set of Local Oscillator Frequency (LOF).

4. The DBXVR of claim 3 wherein said first frequency downward conversion means further comprises a first mixer configured to receive said first set of LOF and said operating frequencies f₁₁, f₁₂, . . . f_{1B1} responsively to generate said common frequency f_{IF}.

5. The DBXVR of claim 1 wherein said second frequency downward conversion means comprises a second coupled combination of a VCO and a PLL to generate a second set of LOF.

6. The DBXVR of claim 5 wherein said second frequency downward conversion means further comprises a pair of second mixers configured to receive said second set of LOF and said common frequency f_{IF} responsively to generate said first set of Baseband Inphase (I) and Quadrature (Q) signals.

7. The DBXVR of claims 1 or 5 wherein said first frequency upward conversion means comprises said second coupled combination of a VCO and a PLL to generate said second set of LOF.

8. The DBXVR of claim 7 wherein said first frequency upward conversion means further comprises a pair of third mixers configured to receive said second set of LOF and said second set of Baseband I and Q signals responsively to generate essentially said common frequency f_{IF}.

9. The DBXVR of claims 1 or 3 wherein said second frequency upward conversion means comprises said first coupled combination of a VCO and a PLL to generate said first set of LOF.

10. The DBXVR of claim 9 wherein said second frequency upward conversion means further comprises a fourth mixer configured to receive said first set of LOF and said common frequency f_{IF} responsively to generate one of said operating frequencies f₁₁, f₁₂, . . . f_{1B1}.

11. The DBXVR of claim 1 wherein said third frequency downward conversion means comprises a third coupled combination of a VCO and a PLL to generate a third set of LOF.

12. The DBXVR of claim 11 wherein said third frequency downward conversion means further comprises a fifth mixer configured to receive said third set of LOF and said operating frequencies f₂₁, f₂₂, . . . , f_{2B2} responsively to generate said down-conversion transitional frequency f_{dtr}.

13. The DBXVR of claims 1 or 11 wherein said third frequency upward conversion means comprises said third coupled combination of a VCO and a PLL to generate a third set of LOF.

14. The DBXVR of claim 13 wherein said third frequency upward conversion means further comprises a sixth mixer configured to receive said third set of LOF and said up-conversion transitional frequency fᵤₜᵣ responsively to generate said operating frequencies f₂₁, f₂₂, . . . , f_{2B2}.

15. The DBXVR of claim 1 wherein said operating frequencies f₁₁, f₁₂, . . . f_{1B1} are within a frequency range of approximately 2412 and 2484 MHz.

16. The DBXVR of claim 15 wherein said operating frequencies f₁₁, f₁₂, . . . f_{1B1} are selected from the group consisting of 2412, 2417, 2422, 2427, 2432, 2437, 2442, 2447, 2452, 2457, 2462, 2467, 2472 and 2484 MHz.

17. The DBXVR of claim 1 wherein said operating frequencies f₂₁, f₂₂, . . . , f_{2B2} are within a frequency range of approximately 5180 and 5805 MHz.

18. The DBXVR of claim 17 wherein said operating frequencies f₂₁, f₂₂, . . . , f_{2B2} are selected from the group consisting of 5180, 5200, 5220, 5240, 5260, 5280, 5300, 5320, 5745, 5765, 5785 and 5805 MHz.

19. The DBXVR of claim 3 wherein said first set of LOF is within a frequency range of approximately 2040 and 2112 MHz.

20. The DBXVR of claim 1 wherein said common frequency f_{IF} is in the range of approximately 372 and 373 MHz

21. The DBXVR of claim 11 wherein said third set of LOF is within a frequency range of approximately 2760 and 3360 MHz.
